(19) United States
(12) Patent Application Publication
(10) Pub. No.: US 2010/0163131 A1
(43) Pub. Date: Jul. 1, 2010

(54) System for pressure testing waste and overflow from a bathtub

(76) Inventors: Jason Kyle Fehr, Kelowna (CA); Shaine Courtney Fehr, Kelowna (CA)

Correspondence Address: Antony C. Edwards, P.O. Box 26020, Westbank, BC, V4T 2G3, CA

(21) Appl. No.: 12/318,377

(22) Filed: Dec. 29, 2008

(51) Int. Cl. F16L 55/10

(52) U.S. Cl. 138/89; 138/90; 138/96 T; 4/680; 4/293; 4/295

(57) ABSTRACT

A system for temporarily sealing bathtub overflow plumbing and waste water plumbing to provide for pressurized testing to locate leaks includes a rigid unitary stop for mating with a corresponding female coupler so as to sandwich therebetween a rim of a bathtub aperture. The female coupler has an internal thread in a cavity in the coupler. The female coupler is adapted for mounting into overflow and waste water plumbing for a bathtub. The female coupler is mountable so as to be adjacent the bathtub apertures. The stop includes an annular rigid sealing flange. An externally threaded cylindrical plug is mounted to the sealing flange. The plug is sized to snugly mate into the female coupler in threaded engagement therein. The threaded engagement draws the sealing flange towards the female coupler sandwiching the bathtub therebetween.

### FIELD OF THE INVENTION

This invention relates generally to the field of devices for handling waste and overflow from a bathtub and in particular to a system for sealing the waste and overflow plumbing for pressure testing of the waste and overflow plumbing from the bathtub.

### BACKGROUND OF THE INVENTION

It is advantageous to pressure test the plumbing in a residential or commercial installation at the so-called rough-in stage of construction so as to include also pressure testing the so-called P-traps on bathtubs. This avoids the requirement for a plumber to have to return to the site after pressure testing of the rough-in plumbing so as pressure test the P-trap once installed between the roughed-in plumbing and the bathtub.

In the prior art applicant is aware of U.S. Pat. No. 7,237,280 which issued Jul. 3, 2007 to Holden, Jr et al. for a Tub Overflow Assembly. Holden discloses the use of an overflow elbow having an externally threaded cylindrical fitting that extends through the bathtub overflow opening, and an internally threaded retainer nut having an integrally moulded test cap which threadably engages over the over flow elbow. The test cap is integrally moulded with the retainer nut and joined to the retainer nut by a thin, breakable connection which may be broken so as to enable removing the test cap after testing of the drain plumbing.

Applicant is also aware of U.S. Pat. No. 6,606,753 which issued Aug. 19, 2003 to Minnick for a Waste and Overflow System for a Bathtub. Minnick teaches the use of an overflow conduit having a threaded end and a overflow cap threaded at one end extending through the overflow opening in the tub into threaded engagement with the threaded end of the conduit, where the overflow cap again has a test cap portion removably connected there to which, once pressure testing has been completed, is removed from the overflow cap to open the overflow passage through the overflow cap. The test cap portion may be integrally moulded to the outer end of the overflow cap by a frangible seam or may be mechanically mounted into the outer end of the overflow cap.

Applicant is also aware of U.S. Pat. No. 4,813,569 which issued Mar. 21, 1989 to Ruiz for a Pressure Test Cap for Plumbing Drain Pipes. Ruiz discloses attaching a screw cap to an externally threaded end portion of the drain pipe, where the screw cap includes a cylindrical portion having internal threads for attachment to the end of the drain pipe. An end wall of the cap has a threaded removable plug mounted therein, the plug serving as a means for injecting water into the pipes for testing or as a means for draining the pipes. Ruiz teaches that his test cap allows all of the in-wall plumbing to be installed during rough and that the connection from the drain pipe is terminated during rough-in a common trap adapter. Ruiz teaches that a sink trap and sink are attached to the common trap adapter much later.

### SUMMARY OF THE INVENTION

In summary, the system according to the present invention for temporarily sealing bathtub overflow plumbing and waste water plumbing to provide for pressurized testing to locate leaks, wherein the bathtub has waste water and overflow apertures formed therein having a first diameter, may be characterized as including in one aspect a rigid unitary stop for mating with a corresponding female coupler so as to sandwich there between a rim of a bathtub aperture.

The female coupler has an internal thread in a cavity in the coupler. The female coupler is adapted for mounting into overflow and waste water plumbing for a bathtub. The female coupler is mountable so as to be adjacent the bathtub apertures.

The stop includes an annular rigid sealing flange. The flange has a second diameter greater than the first diameter of the bathtub apertures. An externally threaded cylindrical plug is mounted to, so as to extend substantially orthogonally from, the sealing flange. The plug is sized to snugly mate into the female coupler in threaded engagement therein. The threaded engagement draws the sealing flange towards the female coupler.

At least one seal is mountable between the flange and the female coupler to engage a rim of the bathtub formed around the apertures in the bathtub.

A torque tool receiver is mounted to the flange so as to be oppositely disposed to the plug. The torque tool receiver mates with a torque tool to rotate the plug in relation to the female coupler so as to engage and tighten the threaded engagement.

The stop is rigid and unitary, that is, is not frangible or otherwise demountable into separate parts so that to decouple from the female receptacle the plug must be unthreaded and completely removed from the cavity in the coupler.

Advantageously, the at least one gasket include pairs of gaskets mountable on opposite sides of the each of the bathtub apertures. Further, and anti-friction shim is preferably provided for mounting between the flange and an adjacent gasket of one of the pairs of gaskets.

In one embodiment the torque tool receiver is a lug and the flange is substantially planer.

In one aspect of the present invention, the plug extends from the flange by a first length or distance, and wherein the first length or distance is greater than the sum of: the thickness of gasket, the thickness of the bathtub rim around the corresponding aperture in the bathtub, and a stand-off distance between the female coupler and the bathtub aperture so that the plug extends sufficiently so as to engage the internal threads in the female coupler when the female coupler is not mounted flush against the bathtub.

### BRIEF DESCRIPTION OF THE DRAWINGS

FIG. 1a is, in side elevation view, a stop according to the present invention.

FIG. 1b is, in plan view, the stop of FIG. 1a.

FIG. 1c is, in bottom view, the stop of FIG. 1a.

FIG. 2 is, in partially exploded view, the test kit according to the present invention aligned for mounting to a bathtub, shown partially cut away, and to the corresponding waste and overflow piping.

FIG. 3 is, in perspective partially exploded and partially cut away view, two of the test kits of FIG. 2 for mounting to a bathtub and corresponding waste and overflow piping.

FIG. 4 is the view of FIG. 3 with the test kits according to the present invention installed.

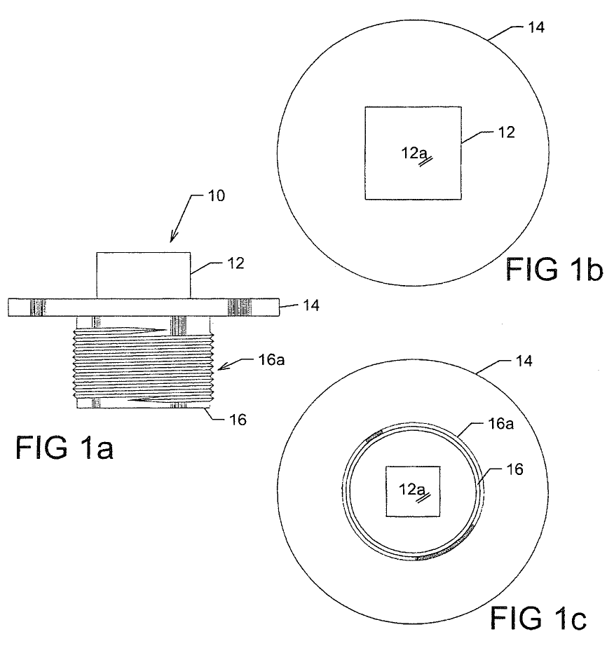

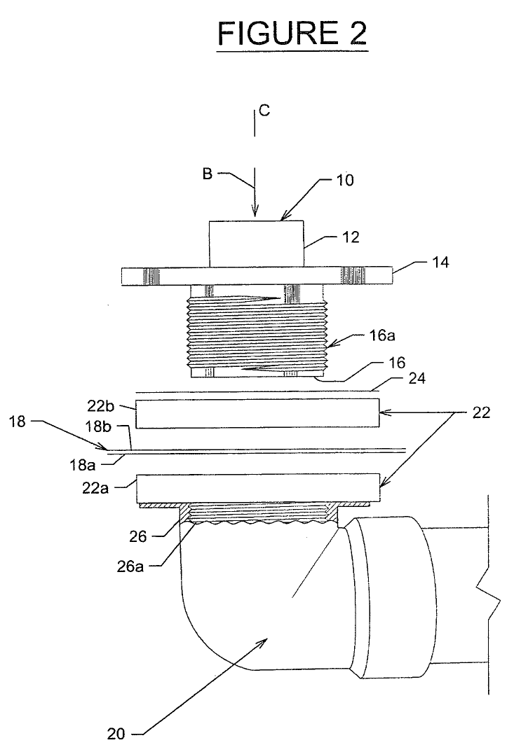

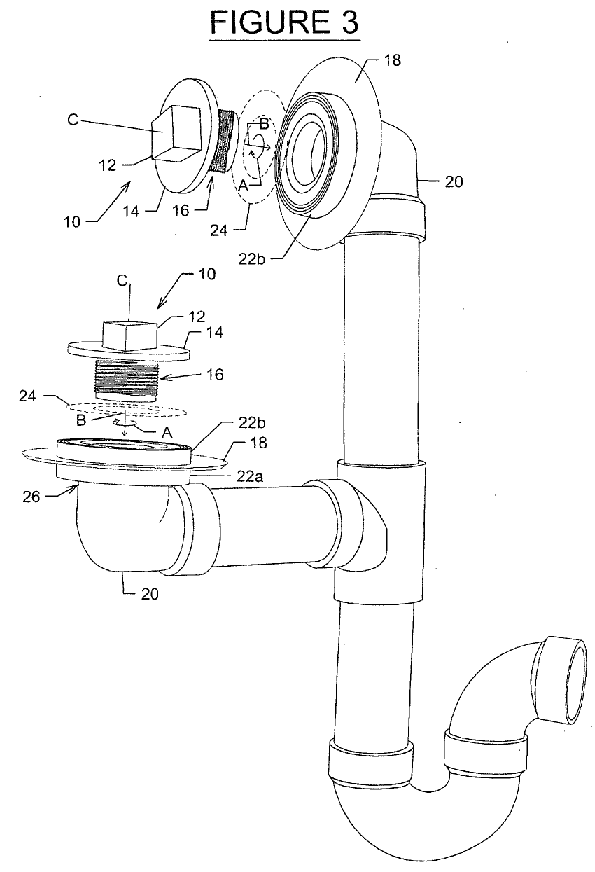

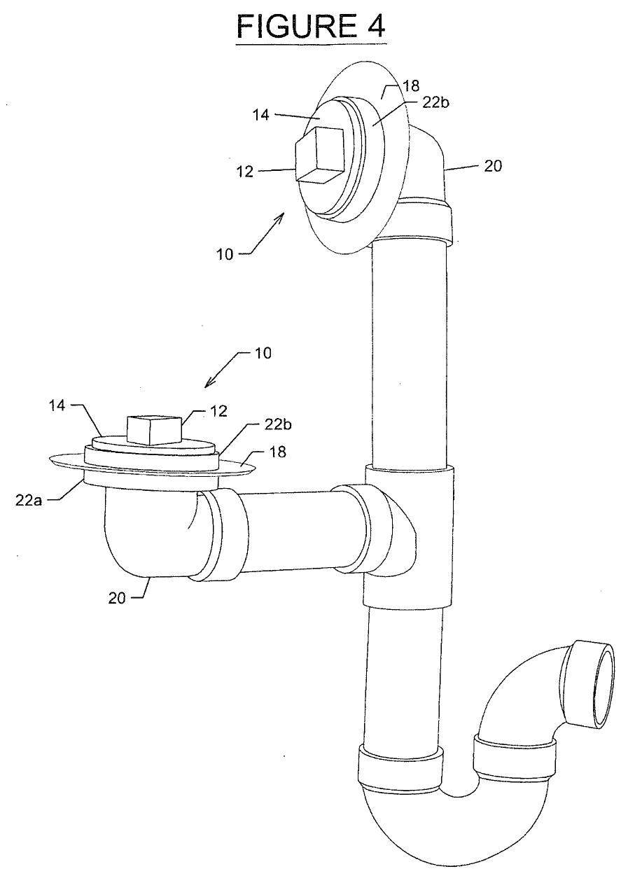

### DETAILED DESCRIPTION OF EMBODIMENTS OF THE INVENTION

The present invention is a test kit enabling plumbers to install the waste and overflow plumbing including the P-trap at the so-called rough-in stage of construction thereby eliminating the need for a plumber to have to return to the construction site to later install the P-trap. This improves over the conventional procedure wherein, initially, the roughed-in plumbing is tested by the contractor, and the P-traps to the bathtubs are later installed thereby requiring that the bathtubs later be filled with water so as again test the waste, overflow and P-trap plumbing for leaks. Thus the test kit according to the present invention saves not only on labour but also on the excessive use of water for what amounts to double testing of the plumbing.

Consequently, the test kit and system according to the present invention, in one aspect, includes a pair of threaded plugs or stops 10. Each stop 10 has a torque tool receiver such as for example square lug 12. Lug 12 may be one inch square so as to provide the head of a nut for applying torque to the stop using a wrench or the like. This is not intended to be limiting as other tool receivers would work, for example a slot for receiving a slotted screwdriver etcetera. Lug 12 is rigidly mounted so as to be centred on a circular flange 14, flange 14 for example having a diameter of 2⅞ inches. A threaded plug 16 having threads 16a around the outer cylindrical surface thereof, is rigidly mounted so as to be centred on flange 14, Plug 16 is oppositely disposed on flange 14 to lug 12. Plug 16 may have a diameter 1½ inch.

Lug 12 may for example have a height of approximately ½ inch measured from the upper surface of flange 14. Plugs 16 may extend downwardly by 1 inch from the opposite lower surface of flange 14. Flange 14 may have a thickness of for example 3/16 of an inch. Stop 10 may be manufactured as a single unitary component, for example of metal, plastics, or other rigid material. Stop 10 may be hollow when viewed from the bottom, that is, when viewed looking into the bottom end of plug 16, with the upper surface 12a of lug 12 providing the seal for the plug and for stop 10. However, no part of stop 10, including upper surface 12a is intended to be frangible or otherwise removable from the rest of stop 10. Rather, it is intended that the entire stop 10 must be removed from the corresponding female coupling 26, better described below, in order to unplug the female coupling.

For each waste or overflow aperture formed in the floor or wall respectively of bathtub 18, and for mounting the waste and overflow piping 20 in sealed engagement against the corresponding apertures in bathtub 18, a pair of resilient gaskets 22 and a paper collar or other thin anti-friction shim or collar 24 are provided. It should be noted that the plug 16 extends sufficiently to engage with threads 26a in female coupling 26 even where there is a small gap or stand-off distance between the coupling 26 and its gasket 22a and the corresponding portion of the bathtub floor or wall.

Thus with the P-trap plumbing mounted so as to extend from the roughed-in plumbing at the wall be adjacent, except for the stand-off distance, to the corresponding waste and overflow apertures in the floor and wall respectively of bathtub 18, first gasket 22a is installed between the female coupling 26 and the exterior surface 18a of bathtub 18, and second gasket 22b is installed flush along the opposite interior surface 18b of tub 18, with the two gaskets aligned so as to cooperate on opposite sides of the corresponding aperture in the bathtub. Anti-friction collar 24 mounts onto the surface of gasket 22b so as to reside between gasket 22b and flange 14 as stop 10 is mounted through the corresponding aperture in bathtub 18 so as to engage in the opposite, internally threaded female coupling 26. Female coupling 26 is advantageously a conventional female coupling such as that provided by OS & B Oakville Stamping & Bending of Oakville, Ontario. The female coupling 26 has a standard size internal threading 26a for which threads 16a on threaded plug 16 are a formed to match. Thus plug 16 may be threaded into female coupling 26 so as to mate flange 14 down onto collar or shim 24 and gasket 22b. Tightening stop 10 in direction A tightens threads 16a into threads 26a so as to translate plug 16 through the gaskets 22 and the aperture in bathtub 18 so as to journal plug 16 into female coupling 26 thereby drawing flange 14 and female coupling 26 together on opposite sides of bathtub 18. This closes the stand-off distance, drawing the gaskets 22a against the bathtub and compressing gaskets 22 to form a water tight seal around the bathtub apertures. Stop 10 thus translates in direction B along centrodial axis of rotation C.

Female couplings 26 are conventionally provided so that the drain, and the drain plug hardware, may be mounted into the floor of the bathtub and so that the overflow hardware may be mounted into the wall of the bathtub through the corresponding apertures so as to engage each of their respective female couplings 26. Thus the use of a pair of stops 10 conveniently seals against the female couplings 26 (which are going to be present and used for mounting the waste and overflow hardware in any event) so that the plumbing 20 may be tested for leaks. Once the testing is complete, the stops 10 are merely removed and the conventional waste and overflow hardware installed into female coupling 26 (which are adapted to do exactly that).

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A system for temporarily sealing bathtub overflow and waste water plumbing to provide for pressurized testing to locate leaks wherein the bathtub has waste water and overflow apertures formed therein having a first diameter, the system comprising:
a female coupling having an internal thread in a cavity of the female coupling, said female coupling adapted for mounting into overflow and waste water plumbing for a bathtub the female coupling mountable so as to be adjacent the bathtub,
a stop including an annular rigid sealing flange, said flange having a second diameter greater than said first diameter, an externally threaded cylindrical plug mounted to, so as to extend substantially orthogonally from, said sealing flange, said plug sized to snugly mate into said female coupling in threaded engagement therein, said threaded engagement drawing said sealing flange forwards said female coupling,
at least one seal mountable between said flange and said female coupling to engage a rim of the bathtub formed around the aperture in the bathtub,
a torque tool receiver mounted to said flange so as to be oppositely disposed to said plug, the torque tool receiver mating with a torque tool to rotate said plug in relation to said female coupling and into said threaded engagement,
wherein said stop is rigid and not frangible so that to decouple from said female receptacle said plug must be unthreaded and completely removed from said cavity.

2. The system of claim 1 wherein said at least one gasket include pairs of gaskets mountable on opposite sides of each of the bathtub apertures.

3. The system of claim 2 further comprising an anti-friction shim mountable between said flange and an adjacent gasket of one of said pairs of gaskets.

4. The system of claim 3 wherein said torque tool receiver is a lug.

5. The system of claim 3 wherein said flange is substantially planer.

6. The system of claim 1 wherein said plug extends from said flange by a first distance, and wherein said first distance is greater than the sum of: the thickness of gasket the thickness of the bathtub rim around the corresponding aperture in the bathtub, and a stand-off distance between said female coupling and the bathtub aperture so that said plug extends sufficiently so to engage said internal threads in said female coupling when said female coupling is not flush against the bathtub.
